(19) United States
(12) Patent Application Publication
(10) Pub. No.: US 2012/0019135 A1
(43) Pub. Date: Jan. 26, 2012

(54) IR COATINGS AND METHODS

(76) Inventors: Miles Rains, Burbank, CA (US); Howard R. Gray, Sebastopol, CA (US)

(21) Appl. No.: 13/187,267

(22) Filed: Jul. 20, 2011

Related U.S. Application Data
(60) Provisional application No. 61/366,114, filed on Jul. 20, 2010.

(51) Int. Cl. H01K 1/32; H01J 9/20

(52) U.S. Cl. 313/578; 445/58

(57) ABSTRACT

A lamp burner having a quartz body comprising a light emitting chamber intermediate a pair of end portions. A filament may be positioned within the light emitting chamber and a multilayer optical coating provided on at least a portion of the body. The coating may comprise a plurality of layers of a first material comprising silica, a plurality of layers of a second material comprising rutile titanium dioxide, and a plurality of layers of a third material having an index of refraction intermediate the indices of refraction of the layers of first material and the layers of second material.

### RELATED APPLICATIONS

The instant application is a non-provisional application of and is co-pending with and claims the priority benefit of U.S. Provisional Patent Application No. 61/366,114 filed Jul. 20, 2010, entitled “IR Coating and Method,” the entirety of which is incorporated herein by reference.

### BACKGROUND

Embodiments of the present subject matter generally relate to multi-layer reflector coatings for various applications, such as, but not limited to, halogen incandescent (HIR) lamps, and the like. Embodiments of the present subject matter also relate to a three material infrared (IR) reflector having rutile titanium dioxide.

It is known in the art to provide thin film optical coatings comprising alternating layers of two or more materials of different indices of refraction to coat reflectors and lamp envelopes. Such coatings or films may be employed to selectively reflect or transmit light radiation or energy from various portions of the electromagnetic radiation spectrum such as ultraviolet, visible and infrared (IR) radiation. The terms radiation and energy may be used interchangeably herein and such use should not limit the scope of the claims appended herewith.

One issue with incandescent lamps and HIR lamps, however, is their relatively low luminous efficacy, with approximately ten to fifteen percent of the light emitted by the tungsten filament being emitted in the visible light spectrum. Remaining energy may be emitted in the IR energy spectrum, dissipated as heat, dissipated through gas losses, end losses, and lead losses. In the industry, an IR reflective coating is commonly deposited on incandescent lamps to reflect IR energy emitted by a filament or arc back to the filament while transmitting the visible light portion of the electromagnetic spectrum emitted by the filament. This decreases the amount of electrical energy supplied to maintain operating temperature of the filament and improves the lamp's respective efficacy. Thus, the more IR energy reflected back to the filament, the more Lumens per Watt (LpW) obtainable by the lamp. Generally, IR coatings are typically formed from stacks of dielectric materials. These materials may include alternating high-index and low-index layers and may be deposited using a variety of techniques such as, but not limited to, reactive sputtering, physical vapor deposition (PVD), low pressure chemical vapor deposition (LPCVD), plasma-enhanced chemical vapor deposition (PECVD), and electron-beam deposition. Such coatings may be deposited upon all types of incandescent lamps including, but not limited to, single and double ended quartz halogen burners. Such coatings may be employed to reflect the shorter wavelength portions of the electromagnetic spectrum, such as the ultraviolet and/or visible light portions emitted by the filament or arc and may also be employed to transmit primarily other portions of the spectrum to provide heat radiation with little or no visible light radiation.

A common method of assessing lamps is by determining a lamp's output in Lumens (L). Lumens may be measured by determining the power radiated by a lamp and weighting the power according to the spectral sensitivity of the eye. For example, a typical 60 W A-line incandescent lamp with no coating, no halogen burner and a tungsten filament emits approximately 900 L providing an efficacy of 15 Lumens per Watt (LpW). A comparable 100 W A-line lamp emits about 1600 L, or 16 LpW. A lamp with a conventional IR coating and a halogen burner, however, may emit the same number of Lumens using less power thereby providing a higher efficiency. Such lamps find particular use in applications such as, but not limited to, torchiere lamps and other fixtures requiring a high lumen output.

A model has been developed by Rolf Bergman of General Electric to predict the effectiveness of various coatings and lamp designs with regard to energy returned to a lamp filament. To understand the Bergman model, several features of IR reflective films may be considered. The terms reflective, reflected and/or reflecting may be used interchangeably herein and such use should not limit the scope of the claims appended herewith. For example, a Hybrid Incandescent Lamp generally employs a filter on the outside of a halogen lamp to reflect emitted IR energy back to the filament or arc. The reflected IR energy may be absorbed by the filament which reduces the amount of electrical energy necessary to maintain filament operating temperature thereby increasing lamp efficacy. An increase in efficacy obtainable by this method may be limited by certain considerations including there is likely no filter that reflects 100 percent of IR energy, the optical coupling of the filter on the lamp envelope and the filament is likely imperfect, and the filament does not likely absorb all of the IR energy reflected back to the filament.

With these considerations in mind, the Bergman model examines a cylindrical IR reflector having a reflectivity of R(1) located concentrically around a cylindrical filament. A multi-pass ray tracing model may be employed to determine the amount of emitted radiation reabsorbed by the filament thereby providing the following relationship:

$${F}_{abs} ( λ ) = {\int }_{λ} \frac{{a}_{λ} ( λ ) GR ( λ )}{1 - ( 1 - {a}_{λ} ( λ ) ) GR ( λ )} d λ \qquad ( 1 )$$

where G is a geometry factor that represents the optical coupling between reflected IR energy and the filament, R represents the reflectance of the IR film or coating, and a(λ) represents the absorptivity of the filament as a function of wavelength. The Bergman model may then be expanded to account for the effects of filament centering. For example, when the filament of a lamp is radially offset, some reflected radiation may miss the filament thereby requiring multiple bounces before reabsorption. Thus, radial offset, whether due to filament misplacement or filament sag, may decrease the amount of IR energy absorbed by the filament thereby leading to a decrease in efficacy. Accounting for filament offset, Equation (1) may be rewritten as:

$${F}_{abs} ( λ ) = {\int }_{λ} \frac{{a}_{λ} ( λ ) GR ( λ ) S}{1 - ( 1 - {a}_{λ} ( λ ) ) GR ( λ ) S} d λ \qquad ( 2 )$$

where S represents the filament offset. Scattering in the film may effectively increase this factor by causing the reflected light to miss the filament thereby having the same practical effect as the filament being off center. Scattering or scatter effects may therefore be taken into account by adjusting the S factor accordingly.

There are many apparatuses and methods in the industry which attempt to increase the efficacy of a lamp by mechanical means or through use of various materials. For example, U.S. Pat. Nos. 6,281,620, 5,675,218, 4,728,848, and 6,659,829 and U.S. Published Patent Application No. 20060163990 provide various methods to align a lamp filament to increase the reabsorption of reflected IR energy or provide methods to shape the lamp so reflected IR energy is more focused. Additional IR filter designs are provided in U.S. Pat. Nos. 4,017,758, 4,160,929, 4,229,066, and 6,239,550. Materials such as niobia (Nb₂O₅), titania (TiO₂), and zirconia (ZrO₂) are commonly used high index materials in IR reflecting interference filters. U.S. Pat. No. 4,701,663 uses such materials. Tantala (Ta₂O₅) is also a known high-index material. U.S. Pat. Nos. 4,588,923, 4,689,519, 6,239,550, 6,336,837 and 6,992,446 provide lamps having IR filters made from tantala and silica.

It has, however, proven difficult to manufacture an optimal IR reflecting interference film in practice. For example, to make an IR film more reflective than the current state of the art IR filters, the film must be thicker; however, as a film's thickness increases, especially at the higher operating temperatures of a halogen lamp envelope (e.g., 800° C.), the film may fail due to mechanical stresses and/or crack or peel off the respective substrate. U.S. Pat. No. 4,701,663 discloses a deposited filter made of titania and silica and admits that severe film stress occurs at a temperature of about 600° C. causing the film to peel off the substrate. U.S. Pat. No. 4,734,614 also recognizes that severe stress occurs in tantala and silica filters at higher temperatures and suggests niobia as a replacement to improve film stress but does not solve the mechanical stress problem. U.S. Pat. Nos. 4,524,410 and 5,425,532 also address mechanical film stress issues in multilayer IR films. Yet another disadvantage with thicker films is that the stress may be sufficient to break the respective halogen lamp envelope. As a result, conventional IR filters made using these materials have limited thickness, meaning the IR reflectance is less than optimal. The thickness for such conventional films is generally between about 1.5 microns and about 4 microns. U.S. Pat. Nos. 4,558,923, 4,949,005 and 6,336,837 provide such conventional films.

Another problem with these conventional films is scattering. For example, the more scattering induced by a film, the less effective the film is at reflecting IR energy back to the filament or arc, as much of the reflected light misses the filament entirely. Eventually, the amount of IR energy lost through scattering may be equal to or greater than the amount of additional IR reflected back to the filament due to greater film thickness. Films deposited at high temperature, such as those made with CVD processes, tend to have a lower scattering effect but have higher stress. Films made by sputtering generally provide films with lower stress but with a higher scattering effect. Thus, there is a need in the art to manufacture a thicker IR reflector that does not suffer from either unacceptably high stresses or unacceptably high scattering. There is also a need in the art for a thin film interference filter having a thickness adaptable to reflect high levels of IR energy back to a lamp filament and still provide low levels of both stress and scattering.

### SUMMARY

Exemplary embodiments of the present subject matter may employ a sputtering process for three material films or coatings. Filters utilizing such coatings according to embodiments of the present subject matter are suitable for high temperatures applications such as standard lighting materials, quartz halogen burners, and the like. Applicant developed a three material coating for consumers approximately five years prior and sputtered the same on only single ended lamp burners; however, despite what knowledge common to those of skill in the art would predict, optical characteristics exhibited by three material films according to embodiments of the present subject matter were unexpectedly high on double ended lamp burners and, as a result, halogen lamps employing films according to embodiments of the present subject matter exhibited an unexpectedly high increase in gain which measures the amount of IR radiation returned to the filament. This may be accomplished by measuring the power needed to bring a filament to a given resistance when the respective lamp is uncoated, repeating the measurement when the lamp is coated, and taking the ratio of the two measurements. More specifically, gain (P₂/P₁) may be represented as the ratio of the measured power when the lamp is coated (P₂) to the measured power of an uncoated burner needed to bring the filament to a given resistance (P₁). Lamps having such exemplary films also exhibited a higher than predicted increase in efficacy measured in Lumens per Watt for the respective film design.

One embodiment of the present subject matter provides a lamp burner comprising a quartz body comprising a light emitting chamber intermediate a pair of end portions and a filament positioned within the light emitting chamber. The burner may also include a multilayer optical coating on at least a portion of the body. The coating may have a plurality of layers of a first material comprising silica, a plurality of layers of a second material comprising rutile titanium dioxide, and a plurality of layers of a third material having an index of refraction intermediate the indices of refraction of said layers of first material silica and said layers of second material.

Another embodiment of the present subject matter provides a double-ended quartz burner having an IR reflecting coating on at least a portion thereof. The coating may comprise layers of a low refractive index material, a high refractive index material, and an intermediate refractive index material.

A further embodiment of the present subject matter may provide a double-ended quartz burner comprising a lamp body with a multilayer IR reflecting coating on at least a portion of the body. The burner may operate at a rated power of one hundred watts or less with a luminous efficiency of at least thirty lumens per watt over a period of time of at least one thousand hours.

An additional embodiment of the present subject matter provides a double-ended quartz halogen incandescent burner having a lamp body with a multilayer IR reflective coating having layers of high refractive index material and low refractive index material on at least a portion of the body. The coating may include layers of material having a refractive index intermediate the refractive indices of the high index and low index materials.

One embodiment of the present subject matter provides a method of improving the lumens per watt a double-ended quartz halogen incandescent burner. The method may include sputter coating at least a portion of the burner with a multilayer IR reflecting coating having layers of a low index refractive index material, a high refractive index material, and an intermediate refractive index material.

An additional embodiment of the present subject matter provides a method comprising the step of providing a lamp burner having a quartz body forming a light emitting chamber housing an incandescent filament intermediate a pair of end portions. The method may also include the step of sputter coating at least a portion of the light emitting chamber to thereby form a multilayer IR reflecting coating having layers of a low refractive index material, a high refractive index material, and an intermediate refractive index material.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1 is a graphical representation of scattering effects on gain for an increasing film thickness.

FIG. 2 is a plan view of one embodiment of the present subject matter.

FIG. 3 is a plan view of another embodiment of the present subject matter.

FIG. 4 is a plan view of a further embodiment of the present subject matter.

FIG. 5 is a perspective view of an exemplary magnetron sputtering system.

FIG. 6 is a perspective view of a sputtering system having tooling allowing more than one degree of rotational freedom.

### DETAILED DESCRIPTION OF THE DRAWINGS

With reference to the figures where like elements have been given like numerical designations to facilitate an understanding of the present subject matter, the various embodiments of improved IR coatings and methods are herein described.

Embodiments of the present subject matter generally relate to the deposition of materials on substrates for thin film coatings and provide utility in making lamps wherein a coating is formed on at least part of the surface of a lamp burner. While the present subject matter relates generally to the manufacture of lamps, the description hereinafter will be described with reference to a halogen lamp, but the claims appended herewith should not be so limited.

Conventional IR reflection coatings or films may comprise a two material design with alternating high-index and low-index layers. The low-index material is generally silica (SiO₂), and the high-index material is generally niobia (Nb₂O₅), tantala (Ta₂O₅), or titania (TiO₂). Typically, a film having a two material design made from any one of these high-index materials in combination with silica may provide an IR filter with varying reflectivity providing varying lamp efficiencies.

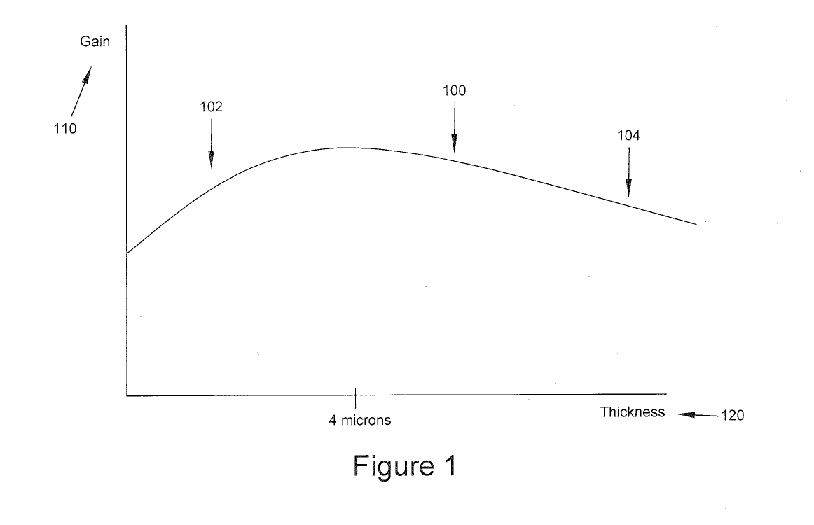

In practice, however, the desired reflectivity is not obtainable as a film having a thickness to provide sufficient reflectance tends to result in excessive scattering thereby effectively lowering the reflectance and reducing the gain as previously discussed. This may also be true with a very high-index material such as rutile TiO₂ as the higher index provides a thinner overall film design, but rutile TiO₂ is also a high-scatter material so thinner designs typically encounter scattering problems seen in thicker designs. FIG. 1 is a graphical representation of scattering effects on gain for an increasing film thickness. With reference to FIG. 1, a curve 100 is provided demonstrating how scattering typically affects gain 110 provided by an IR filter as film thickness 120 increases. In a first portion 102 of the curve 100, scattering is low enough that sufficient IR is reflected back to the filament thereby increasing gain 110. At a film thickness 120 of approximately four microns, however, scattering effects increase enough to prevent any additional rise in gain. In a second portion 104 of the curve 100, it is evident that at greater film thickness 120, scattering effects cause significant reflected IR energy to miss the filament such that gain 110 decreases despite the specular reflectance of the respective film. Thus, embodiments of the present subject matter may provide exemplary techniques to lower film scattering and provide coatings or films with higher gain.

Film scatter is directly related to film structure which is, in turn, dependent upon particle or atomic energetics present while the film is being deposited. This is demonstrated by the Thorton diagram which illustrates how film structure changes with deposition energy and discussed in books such as Thin Film Deposition: Principles & Practice, by Donald L. Smith. For example, when a deposited material is deposited with such little energy that surface diffusion is negligible, a resulting film may provide a porous, columnar structure with a high amount of scattering. In contrast, when the deposited material is deposited with a high amount of energy, a resulting film may provide a denser and less porous structure with a low amount of scattering per unit thickness. This may be explained by particle or atomic energetics, that is, the more energy the deposited atoms have, the more the atoms move about and shift into available space rather than forming a columnar structure. On the other hand, if the deposited material is deposited with too much energy, a resultant film may have a tendency to become highly crystalline and induce a greater amount of scattering.

Exemplary methods according to embodiments of the present subject matter may control the energy of deposited materials by, for example, heating the substrate thereby resulting in more surface mobility for deposited atoms and denser films. Additional embodiments may deposit films using AC sputtering which, while more difficult than conventional sputtering, provides higher deposition energies. Further embodiments may also deposit films employing auxiliary plasmas such as, but not limited to, microwaves and ion guns, which generally bombard a forming film with high energy particles to thereby provide a denser film. Additionally, as different materials provide different optical properties, including scattering, various material combinations thereof may also be used to lower scattering effects.

Certain embodiments of the present subject matter may provide higher gain by employing a three material design comprising SiO₂, rutile TiO₂, and Ta₂O₅. The rutile TiO₂ may permit the use of a thinner design, while the tantala (Ta₂O₅) allows the use of a small enough amount of rutile titania (TiO₂) that film scatter is not prohibitive. While rutile TiO₂ is a crystalline and more highly scattering form of TiO₂, rutile TiO₂ also provides the highest index of refraction of any form of titania thereby making the material useful despite its scattering characteristics. Additionally, tantala is an exemplary material for embodiments of the present subject matter as the material provides an index between that of silica (SiO₂) and rutile TiO₂ and provides a low scattering effect offsetting to some degree the higher scatter resulting from the use of rutile TiO₂.

In the industry, three material coatings are not generally employed to increase efficiency or gain as such a design requires the use of extra materials in a deposition chamber and complicates the respective film-forming process. Additionally, three material coatings may be more expensive and time-consuming to produce; thus, the industry generally continue making the less efficient but easier to process two material IR filters.

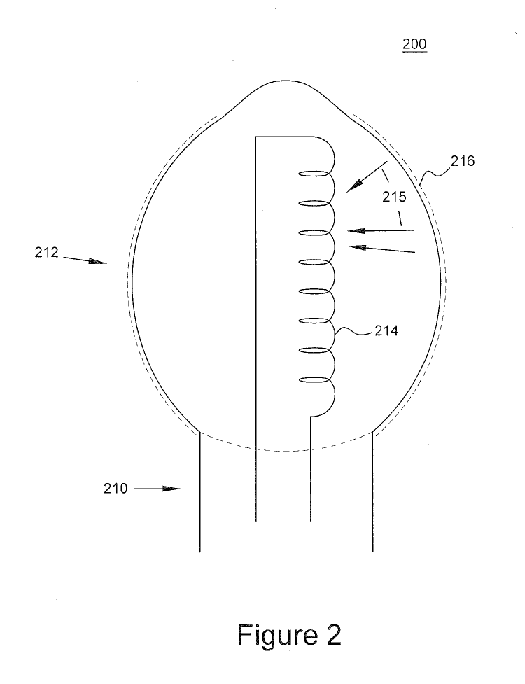

FIG. 2 is a plan view of one embodiment of the present subject matter. With reference to FIG. 2, a single-ended lamp burner 200 has a quartz body 210 comprising a light emitting chamber 212 and a filament 214 positioned within the light emitting chamber 212. A multilayer optical coating 216 may be deposited or sputtered on at least a portion of the chamber 212. The filament 214 may be thick but relatively short, meaning that even though the filament 214 is a large target, much of the reflected IR radiation or energy 215 misses the filament 214 due to passing above or below the filament 214. One single-ended lamp burner embodiment may be 12V, however, such an example should not limit the scope of the claims appended herewith.

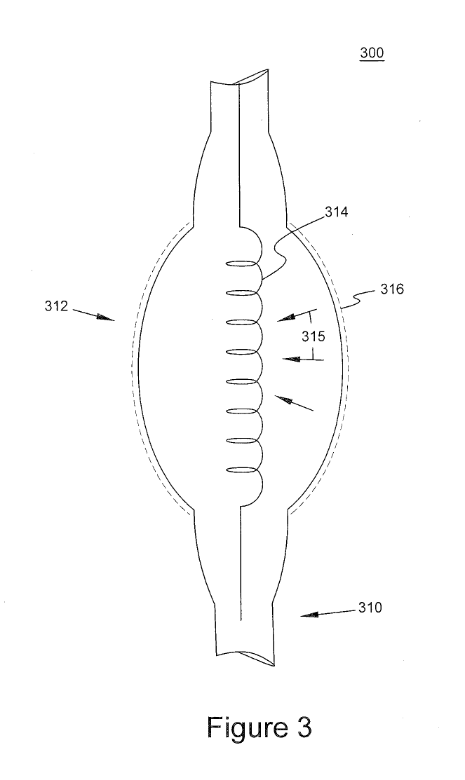

FIG. 3 is a plan view of another embodiment of the present subject matter. With reference to FIG. 3, a double-ended lamp burner 300 has a quartz body 310 comprising a light emitting chamber 312 and a filament 314 positioned within the light emitting chamber 312. A multilayer optical coating 316 may be deposited or sputtered on at least a portion of the chamber 312. The filament 314 in the doubled-ended burner 300 is longer and reduces the amount of radiation 315 that passes above or below the filament 314. The filament 314 may also be thinner, making the filament 314 more difficult to hit with reflected IR energy or radiation 315. One double-ended lamp burner embodiment may be 120V, however, such an example should not limit the scope of the claims appended herewith. As both the embodiments depicted in FIGS. 2 and 3 provide certain geometry issues making it difficult to couple reflected IR energy with the respective filament, one would expect a three material coating to perform about equally on both lamps. This, however, was not the case as when the three-material coating was deposited on a double-ended burner 300, the gain was unexpectedly high at 1.62 and the single-ended quartz burner 200 exhibited a gain of 1.42. Thus, the double ended quartz burner 300 embodiment exhibited a significantly better than expected performance. The single-ended quartz burner 200 displayed a greater sensitivity to scatter than the double-ended quartz burner 300, thus, the IR coating 316 on the double-ended burner 300 may be, in certain embodiments, made thicker before scattering becomes prohibitive, meaning gain would continue to increase in embodiments of the present subject matter once the respective film reaches a thickness of four microns thereby resulting in a higher efficiency lamp than predicted. Exemplary coatings according to embodiments of the present subject matter may include, but are not limited to, SiO₂, Ta₂O₅, and rutile TiO₂. For example, other materials of intermediate indices, such as Nb₂O₅, may also be used instead of Ta₂O₅.

Table 1 below provides another exemplary, but non-limiting, coating according to one embodiment of the present subject matter.

TABLE 1

| Layer Number | Material | Thickness (nm) |
|---|---|---|
| 1 | SiO₂ | 50 |
| 2 | TABATH | 11.11 |
| 3 | SiO₂ | 22.15 |
| 4 | TABATH | 28.18 |
| 5 | TICVD | 52.18 |
| 6 | TABATH | 38.02 |
| 7 | SiO₂ | 154.24 |
| 8 | TABATH | 27.47 |
| 9 | TICVD | 60.32 |
| 10 | TABATH | 21.18 |
| 11 | SiO₂ | 153.87 |
| 12 | TABATH | 14.2 |
| 13 | TICVD | 71.79 |
| 14 | TABATH | 11.52 |
| 15 | SiO₂ | 154.97 |
| 16 | TABATH | 10.9 |
| 17 | TICVD | 72.25 |
| 18 | TABATH | 13.84 |
| 19 | SiO₂ | 151.73 |
| 20 | TABATH | 16.87 |
| 21 | TICVD | 64.48 |
| 22 | TABATH | 24.32 |
| 23 | SiO₂ | 161.74 |
| 24 | TABATH | 55.24 |
| 25 | TICVD | 95.08 |
| 26 | TABATH | 56.59 |
| 27 | SiO₂ | 164.6 |
| 28 | TABATH | 37.53 |
| 29 | TICVD | 47.8 |
| 30 | TABATH | 42.9 |
| 31 | SiO₂ | 174.9 |
| 32 | TABATH | 63.37 |
| 33 | TICVD | 70.03 |
| 34 | TABATH | 35.75 |
| 35 | SiO₂ | 3.62 |
| 36 | TABATH | 17.18 |
| 37 | SiO₂ | 172.22 |
| 38 | TABATH | 51.94 |
| 39 | TICVD | 90.66 |
| 40 | TABATH | 62.61 |
| 41 | SiO₂ | 191.49 |
| 42 | TABATH | 30.98 |
| 43 | SiO₂ | 10.09 |
| 44 | TABATH | 25.22 |
| 45 | TICVD | 121.78 |
| 46 | TABATH | 53.97 |
| 47 | SiO₂ | 12.18 |
| 48 | TABATH | 8.48 |
| 49 | SiO₂ | 198.09 |
| 50 | TABATH | 27.51 |
| 51 | SiO₂ | 33.88 |
| 52 | TABATH | 79.32 |
| 53 | TICVD | 72.57 |
| 54 | TABATH | 44.3 |
| 55 | SiO₂ | 15.57 |
| 56 | TABATH | 4.84 |
| 57 | SiO₂ | 202.99 |
| 58 | TABATH | 16.44 |
| 59 | SiO₂ | 28.96 |
| 60 | TABATH | 47.08 |
| 61 | TICVD | 62.66 |
| 62 | TABATH | 43.07 |
| 63 | SiO₂ | 82.96 |

The exemplary coating represented by the plural layers provided in Table 1 provides twenty layers of low index material (e.g., SiO₂) having a total thickness of 2140.25 nm and representing approximately 53% of the total thickness. Twelve layers of high index material (TICVD) are provided having a total thickness of 881.6 nm and representing approximately 21.8% of the total thickness. Thirty one layers of intermediate index material (TABATH) is provided having a total thickness of 1021.93 nm and representing approximately 25.2% of the total thickness. It should be noted, however, that the coating represented by the plural layers provided in Table 1 is exemplary only and should not limit the scope of the claims appended herewith as multilayer IR reflecting coatings according to embodiments of the present subject matter may include any number of layers of tantala, silica and/or rutile titania having different thicknesses. Further, while coatings have been described as employing tantala, silica and rutile titania, additional coatings may include one or several layers of titanium dioxide, niobium pentoxide, tantala, hafnium dioxide, silica, etc. to provide large optical, thermal and mechanical advantages in the construction of other exemplary coatings.

Tables 2, 3 and 4 below provide exemplary, but non-limiting, wavelength indices for the silica, tantala and rutile titania layers provided in Table 1.

TABLE 2
Tantala

| Wavelength | Index |
|---|---|
| 250 | 2.75 |
| 275 | 2.52 |
| 290 | 2.45 |
| 300 | 2.4 |
| 310 | 2.37 |
| 320 | 2.35 |
| 335 | 2.32 |
| 350 | 2.3 |
| 400 | 2.26 |
| 450 | 2.225 |
| 500 | 2.2 |
| 550 | 2.181 |
| 600 | 2.163 |
| 650 | 2.15 |
| 700 | 2.14 |
| 800 | 2.128 |
| 900 | 2.116 |
| 1000 | 2.109 |
| 1250 | 2.097 |
| 1500 | 2.088 |
| 2500 | 2.08 |

TABLE 3
SiO₂

| Wavelength | Index |
|---|---|
| 300 | 1.488 |
| 350 | 1.477 |
| 400 | 1.467 |
| 450 | 1.465 |
| 500 | 1.462 |
| 550 | 1.46 |
| 600 | 1.458 |
| 650 | 1.456 |
| 700 | 1.455 |
| 900 | 1.452 |
| 1000 | 1.45 |
| 1300 | 1.447 |
| 1500 | 1.444 |
| 2000 | 1.438 |
| 3000 | 1.419 |
| 3500 | 1.406 |
| 3800 | 1.396 |
| 4000 | 1.389 |
| 4300 | 1.377 |
| 4500 | 1.365 |
| 5000 | 1.342 |

TABLE 4
TiCVD

| Wavelength | Index |
|---|---|
| 350 | 3.12 |
| 360 | 3.06 |
| 410 | 2.85 |
| 420 | 2.785 |
| 500 | 2.628 |
| 600 | 2.537 |
| 800 | 2.463 |
| 1000 | 2.44 |
| 2000 | 2.4 |
| 3000 | 2.35 |
| 5000 | 2.35 |

It should be noted that exemplary coatings according to embodiments of the present subject having indices provided in Tables 2, 3 and 4 are exemplary only and should not limit the scope of the claims appended herewith as multilayer IR reflecting coatings according to embodiments of the present subject matter may include varying thicknesses and/or optical properties. Further, while coatings have been described as employing tantala, silica and rutile titania, additional coatings may include one or several layers of other materials as previously described.

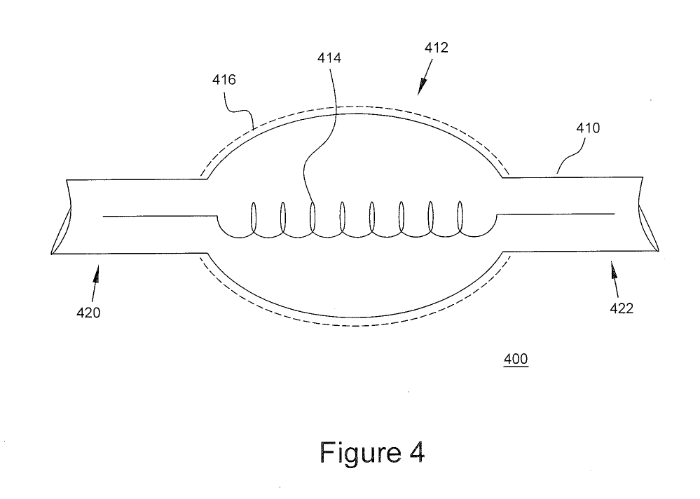

FIG. 4 is a plan view of a further embodiment of the present subject matter. With reference to FIG. 4, one embodiment of the present subject matter may include a lamp burner 400 having a quartz body 410 comprising a light emitting chamber 412 intermediate a pair of end portions 420, 422. Exemplary light emitting material may include materials such as, but not limited to, glass, quartz glass, ceramic materials and the like. For example, the burner 400 may be employed in a modified spectrum lamp having an envelope made from neodynium doped glass which absorbs specific wavelengths of the emitted radiation and results in a light with a predetermined color. A filament 414 may be positioned within the light emitting chamber 412. Further, a multilayer optical coating 416 may be deposited or sputtered on at least a portion of the body 410. In one embodiment, the coating 416 may include a plurality of layers of a first material comprising silica, a plurality of layers of a second material comprising rutile titanium dioxide, and a plurality of layers of a third material having an index of refraction intermediate the indices of refraction of the layers of the first material and the layers of the second material. In one embodiment, the third material may be tantala. In another embodiment, the third material may be niobia. In a further embodiment of the present subject matter layers of high index material are not adjacent to layers of low index material. The burner 400 may be a double-ended burner as depicted or may be a single-ended burner. These burners may be any common wattage such as, but not limited to, 20 W, 30 W, 40 W, 50 W, 60 W, 100 W or more and may have various luminous efficiencies of thirty LpW, less than thirty LpW or greater than thirty LpW. In one embodiment, the burner may operate with a luminous efficiency of at least thirty LpW over at least five hundred hours of operation. In an additional embodiment, the burner may operate with a luminous efficiency of at least thirty LpW over at least one thousand hours of operation. The burner 400 may be employed as a light source in a variety of lamps including, but not limited to, an A-line lamp, a general service lamp, a modified spectrum lamp, a reflector lamp, a parabolic reflector lamp, an ER/BR lamp, and a torchiere.

Another embodiment of the present subject matter provides a double-ended quartz burner having an infrared reflecting coating on at least a portion thereof, the coating comprising layers of a low refractive index material, a high refractive index material, and an intermediate refractive index material. This coating may include layers of silica, titania and an intermediate refractive index material. The intermediate refractive index material may be, but is not limited to, tantala or niobia. The layers of intermediate refractive index material may also be titania substantially in the rutile phase. Exemplary titania, may in one embodiment, have an index of refraction of at least 2.6 at a wavelength of 550 nm. In another embodiment, the burner may operate at a rated power of one hundred watts or less with a luminous efficiency of at least thirty lumens per watt over a period of time of at least one thousand hours or less. The gain of an exemplary burner may be at least 1.5 or 1.6.

One embodiment of the present subject matter may employ a halogen burner with an exemplary three material coating in a modified spectrum lamp having an envelope made from neodynium doped glass. Pairing the higher efficiency halogen burner with a typical modified spectrum lamp envelope may thus result in a higher efficiency lamp retaining the pleasing color of the modified spectrum lamp desired by consumers. A further embodiment may employ an exemplary halogen burner in any general service lamp (GSL) to provide higher efficiency lighting and in any lamp with an output greater than 3000 lumens, such as a torchiere light to provide high efficiency lamps with a high lumen output. Yet an additional embodiment may employ an exemplary halogen burner in any A-line lamp to provide higher efficiency lighting or in reflector lamps (PAR lamps, ER/BR lamps) to provide higher efficiency lighting. Other embodiments may employ an exemplary halogen burner in stage or studio lighting to provide higher efficiency lighting or provide small halogen burners with the three material coating described above.

Of course, it is obvious to one skilled in the art that the scope of the claims appended herewith encompass variations in reflection or reflector design and coatings or films may be thinner or thicker than describe, possess varying gains, and possess varying optical characteristics and luminous efficiency than that specifically described in examples above. Thus, these examples should in no way limit the scope of the claims appended herewith.

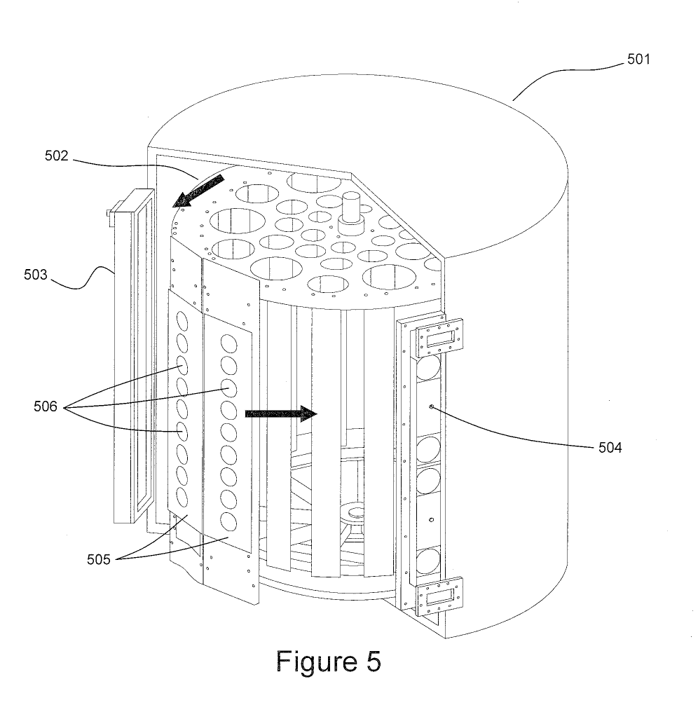

Multilayer coatings according to embodiments of the present subject matter may be manufactured or produced by any number of methods. For example, exemplary coatings may be sputtered utilizing a magnetron sputtering system. FIG. 5 is a perspective view of an exemplary magnetron sputtering system. With reference to FIG. 5, the magnetron sputtering system may utilize a cylindrical, rotatable drum 502 mounted in a vacuum chamber 501 having sputtering targets 503 located in a wall of the vacuum chamber 501. Plasma or microwave generators 504 known in the art may also be located in a wall of the vacuum chamber 501. Substrates 506 may be removably affixed to panels or substrate holders 505 on the drum 502.

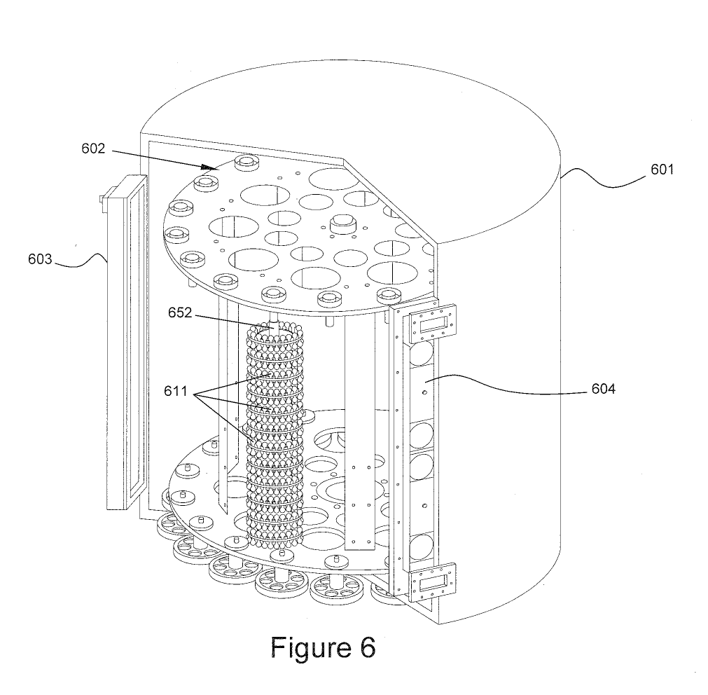

Embodiments of the present subject matter may also be manufactured in sputtering systems having tooling allowing more than one degree of rotational freedom. FIG. 6 is a perspective view of a such a sputtering system. With reference to FIG. 6, an exemplary sputtering system may utilize a substantially cylindrical, rotatable drum or carrier 602 mounted in a vacuum chamber 601 having sputtering targets 603 located in a wall of the vacuum chamber 601. Plasma or microwave generators 604 known in the art may also be located in a wall of the vacuum chamber 601. The carrier 602 may have a generally circular cross-section and is adaptable to rotate about a central axis. A driving mechanism (not shown) may be provided for rotating the carrier 602 about its central axis. A plurality of pallets 650 may be mounted on the carrier 602 in the vacuum chamber 670. Each pallet 650 may comprise a rotatable central shaft 652 and one or more disks 611 axially aligned along the central shaft 652. The disks 611 may provide a plurality of spindle carrying wells positioned about the periphery of the disk 611. Spindles may be carried in the wells, and each spindle may carry one or more substrates adaptable to rotate about it respective axis. Additional particulars and embodiments of this exemplary system are further described in co-pending and related U.S. patent application Ser. No. 12/155,544, filed Jun. 5, 2008, entitled, “Method and Apparatus for Low Cost High Rate Deposition Tooling,” and co-pending U.S. application Ser. No. 12/289,398, filed Oct. 27, 2008, entitled, “Thin Film Coating System and Method,” the entirety of each being incorporated herein by reference. Of course, embodiments of the present subject matter may also be manufactured using an in line coating mechanism or sputtering system and/or any conventional chemical vapor deposition system. Further, to obtain sufficient uniformity in coating may require plural rotations past the target or may require multiple targets.

One embodiment of the present subject matter may include a method of depositing films on a substrate. This may be accomplished utilizing the magnetron systems depicted in FIGS. 5 and 6, inline systems or other conventional sputtering systems. The method may include providing a vacuum chamber having one or more microwave generators therein and positioning a target of silicon or another substrate within the vacuum chamber. Power may then be applied to the target to thereby effect sputtering of a material from the target. Oxygen may be introduced into the vacuum chamber proximate to the microwave generator and power applied to the microwave generator thereby generating a plasma containing monatomic oxygen. The substrate may be moved past the target to effect the deposition of a material on the substrate and then moved past the microwave generator to effect the reaction of the material with oxygen to form, for example, tantala, niobia, silica, etc. on the substrate. Of course, additional layers of materials may be sputter deposited upon the substrate or surface thereof.

In the aforementioned processing methods and systems, one exemplary method may be provided to improve the lumens per watt of a double-ended quartz halogen incandescent burner by sputter coating at least a portion of the burner with a multilayer infrared reflecting coating having layers of a low index refractive index material, a high refractive index material, and an intermediate refractive index material. In one embodiment, the coating may include layers of silica, titania and the intermediate refractive index material. This intermediate refractive index material may be, but is not limited to, tantala or niobia or may be titania substantially in the rutile phase. The gain of such a halogen burner may be at least 1.5, and the lumens per watt of the burner with the coating is at least thirty over at least the first five hundred or even one thousand hours of operation of the burner. The burner may be operated as a light source in a variety of lamps including, but not limited to, an A-line lamp, a general service lamp, a modified spectrum lamp, a reflector lamp, a parabolic reflector lamp, an ER/BR lamp, and a torchiere.

Another exemplary method may include providing a lamp burner having a quartz body forming a light emitting chamber housing an incandescent filament intermediate a pair of end portions and sputter coating at least a portion of the light emitting chamber to form a multilayer infrared reflecting coating having layers of a low refractive index material, a high refractive index material, and an intermediate refractive index material. This sputter coating may include the reactive sputter deposition of silica and/or may include the reactive sputter deposition of titania. Of course, this sputter coating may also include the reactive sputter deposition of titania in substantially the rutile phase and/or include the reactive sputter deposition of tantala or niobia. In one embodiment, the sputter coating may include the reactive sputter deposition of silica, titania, and tantala or niobia.

As shown by the various configurations and embodiments illustrated in FIGS. 1-6, the various embodiments of improved IR coatings and methods have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A lamp burner comprising:
a quartz body comprising a light emitting chamber intermediate a pair of end portions;
a filament positioned within said light emitting chamber; and
a multilayer optical coating on at least a portion of said body, said coating comprising a plurality of layers of a first material comprising silica, a plurality of layers of a second material comprising rutile titanium dioxide, and a plurality of layers of a third material having an index of refraction intermediate the indices of refraction of said layers of first material and said layers of second material.

2. The burner of claim 1 wherein said third material comprises tantala.

3. The burner of claim 1 wherein said third material comprises niobia.

4. The burner of claim 1 having a luminous efficiency of at least thirty lumens per watt.

5. The burner of claim 4 wherein said lamp is rated at one hundred watts or less.

6. The burner of claim 5 wherein said lamp operates with a luminous efficiency of at least thirty lumens per watt over at least five hundred hours of operation.

7. The burner of claim 5 wherein said lamp operates with a luminous efficiency of at least thirty lumens per watt over at least one thousand hours of operation.

8. The burner of claim 4 wherein said lamp operates with a luminous efficiency of at least thirty lumens per watt over at least one thousand hours of operation.

9. The burner of claim 1 used as a light source in a type of lamp selected from the group consisting of an A-line lamp, a general service lamp, a modified spectrum lamp, a reflector lamp, a parabolic reflector lamp, an ER/BR lamp, and a torchiere.

10. The burner of claim 9 used in a general service lamp.

11. The burner of claim 9 used in a modified spectrum lamp.

12. The burner of claim 9 used in an A-line lamp.

13. The burner of claim 1 wherein said layers of a first material are not adjacent to said layers of second material.

14. A double-ended quartz burner having an infrared reflecting coating on at least a portion thereof, said coating comprising layers of a low refractive index material, a high refractive index material, and an intermediate refractive index material.

15. The burner of claim 14 wherein said coating comprises layers of silica, titania and said intermediate refractive index material.

16. The burner of claim 15 wherein said layers of intermediate refractive index material comprise tantala or niobia.

17. The burner of claim 16 wherein said layers of intermediate refractive index material comprise titania substantially in the rutile phase.

18. The burner of claim 17 wherein said layers of titania have an index of refraction of at least 2.6 at a wavelength of 550 nm.

19. A double-ended quartz burner comprising a lamp body with a multilayer infrared reflecting coating on at least a portion of said body, wherein said burner operates at a rated power of one hundred watts or less with a luminous efficiency of at least thirty lumens per watt over a period of time of at least one thousand hours.

20. The burner of claim 19 wherein said coating comprises layers of silica, titania, and a third material having an index of refraction intermediate the silica and titania.

21. The burner of claim 20 wherein said third material comprises tantala.

22. The burner of claim 20 wherein said third material comprises niobia.

23. The burner of claim 19 having a gain of at least 1.5.

24. The burner of claim 23 having a gain of at least 1.6.

25. In a double-ended quartz halogen incandescent burner comprising a lamp body with a multilayer infrared reflective coating having layers of high refractive index material and low refractive index material on at least a portion of said body, the improvement wherein said coating includes layers of material having a refractive index intermediate the refractive indices of the high index and low index materials.

26. A method of improving the lumens per watt a double-ended quartz halogen incandescent burner comprising sputter coating at least a portion of the burner with a multilayer infrared reflecting coating having layers of a low index refractive index material, a high refractive index material, and an intermediate refractive index material.

27. The method of claim 26 wherein the coating comprises layers of silica, titania and the intermediate refractive index material.

28. The method of claim 27 wherein the layers of intermediate refractive index material comprise tantala or niobia.

29. The method of claim 28 wherein the layers of intermediate refractive index material comprise titania substantially in the rutile phase.

30. The method of claim 26 wherein the gain is at least 1.5.

31. The method of claim 26 wherein the lumens per watt of the burner with the coating is at least thirty over at least the first one thousand hours of operation of the burner.

32. The method of claim 26 further comprising operating the burner as a light source in a type of lamp selected from the group consisting of an A-line lamp, a general service lamp, a modified spectrum lamp, a reflector lamp, a parabolic reflector lamp, an ER/BR lamp, and a torchiere.

33. A method comprising:
providing a lamp burner having a quartz body forming a light emitting chamber housing an incandescent filament intermediate a pair of end portions;
sputter coating at least a portion of the light emitting chamber to thereby form a multilayer infrared reflecting coating having layers of a low refractive index material, a high refractive index material, and an intermediate refractive index material.

34. The method of claim 33 wherein said sputter coating includes the reactive sputter deposition of silica.

35. The method of claim 33 wherein said sputter coating includes the reactive sputter deposition of titania.

36. The method of claim 35 wherein said sputter coating includes the reactive sputter deposition of titania in substantially the rutile phase.

37. The method of claim 33 wherein said sputter coating includes the reactive sputter deposition of tantala or niobia.

38. The method of claim 33 wherein said sputter coating includes the reactive sputter deposition of silica, titania, and tantala or niobia.
